(19) United States
(12) Patent Application Publication
(10) Pub. No.: US 2011/0154426 A1
(43) Pub. Date: Jun. 23, 2011

(54) METHOD AND SYSTEM FOR CONTENT DELIVERY

(76) Inventors: Ingo Tobias Doser, Villingen-Schwenningen (DE); Yongying Gao, Beijing (CN); Ying Chen, San Diego, CA (US); Yuwen Wu, Beijing (CN); Bongsun Lee, Cupertino, CA (US)

(21) Appl. No.: 12/737,844

(22) PCT Filed: Aug. 19, 2009
(86) PCT No.: PCT/US2009/004723

§ 371 Date: Feb. 22, 2011

Related U.S. Application Data
(60) Provisional application No. 61/189,841, filed on Aug. 22, 2008.
(60) Provisional application No. 61/194,324, filed on Sep. 26, 2008.

(51) Int. Cl. H04N 7/173

(52) U.S. Cl. 725/118

(57) ABSTRACT

A method and system of content delivery provide availability of at least two versions of content by delivering data for a first version of content, a difference data representing at least one difference between the first version and a second version of content, and metadata derived from two transformation functions that relate the first version and the second version of content respectively to a master version.

### CROSS-REFERENCE TO RELATED APPLICATIONS

This application claims priority to U.S. Provisional Application Ser. No. 61/189,841, “METHOD AND SYSTEM FOR CONTENT DELIVERY” filed on Aug. 22, 2008; and to U.S. Provisional Application Ser. No. 61/194,324, “DEFINING THE FUTURE CONSUMER VIDEO FORMAT” filed on Sep. 26, 2008, both of which are herein incorporated by reference in their entirety.

### BACKGROUND

Consumer viewing of video content has begun to diverge into two distinct environments: the traditional home video environment, which typically consists of a small display in a bright room, and the new home theater environment, which consists of a large, high definition display or projector in a dark, carefully controlled room. Current video mastering and delivery processes, e.g., for home video such as digital versatile disk (DVD) and high definition DVD (HD-DVD), only address the home video environment but not the home theatre environment.

Compared with the current viewing practice, home theatre viewing requires a higher encoding precision, with associated encoding and compression techniques that are not commonly used in current practice. Thus, the new encoding practice enables higher signal accuracy to be used for different viewing situations, and different color decisions (i.e., mathematical transfer functions applied to picture or content materials) may be arrived at during a color grading session.

### SUMMARY OF THE INVENTION

Embodiments of the present invention relate to a method and system that provide at least two versions of video content suitable for use in different viewing environments.

One embodiment provides a method of preparing video content for delivery, which includes: providing a first version of video content; providing metadata for use in transforming at least a first parameter value associated with the first version to at least a second parameter value associated with a second version of content; and providing difference data representing at least one difference between the first version of video content and the second version of video content. In this embodiment, the first version of content is related to a master version through a first function, and the second version of video content is related to the master version through a second function; and the metadata is derived from the first function and the second function.

Another embodiment provides a system, which includes at least one processor configured for generating difference data using a first version of content, a second version of content, and metadata for use in transforming at least a first parameter value associated with the first version to at least a second parameter value associated with the second version of content. In this embodiment, the first version of content is related to a master version through a first function, and the second version of video content is related to the master version through a second function; and the metadata is derived from the first function and the second function.

Another embodiment provides a system, which includes a decoder configured for decoding data to generate at least a first version of content and a difference data representing at least one difference between the first version of content and a second version of content; and a processor for generating the second version of content from the first version of video content, the difference data, and metadata provided to the processor. In this embodiment, the first version of content is related to a master version through a first function, and the second version of video content is related to the master version through a second function; and the metadata is derived from the first function and the second function, for use in transforming at least a first parameter value associated with the first version to at least a second parameter value associated with the second version of content.

### BRIEF DESCRIPTION OF THE DRAWINGS

The teachings of the present invention can be readily understood by considering the following detailed description in conjunction with the accompanying drawings, in which:

FIG. 1 illustrates a concept of creating different versions of content from a master version;

FIG. 2 illustrates data or information needed for providing different versions of content;

FIG. 3 illustrates the processing of data or information related to the delivery of different content versions;

FIG. 4 illustrates the processing of data or information at a receiver or decoder;

FIG. 5 illustrates content creation of multiple versions for different display reference models; and

FIG. 6 illustrates a receiver for selecting a content version from multiple options for different display models.

To facilitate understanding, identical reference numerals have been used, where possible, to designate identical elements that are common to the figures.

### DETAILED DESCRIPTION

Embodiments of the invention provide a method and system that address different viewing practices, e.g., by delivering content that allows access to a first version of the content compatible with a first viewing practice and associated playback hardware and software, and at least a second version compatible with a second viewing practice, which may be incompatible with the first viewing practice.

In one example, the two versions are, different color corrected versions of the same content, i.e., both derived from the same original or master version, but with different color decisions. However, instead of delivering the entire content data for both versions, a method of the present invention delivers only the content data for the first version and certain additional data, which allows the second version to be derived or reconstructed from the first version at the receiving end. By re-using or sharing the content data (e.g., picture or video) of the first version with the second version, requirements for data size and rate can be reduced, resulting in improved resource utilization.

Embodiments of the invention are generally applicable for making available, to a receiver or user, any number of different versions of the same content, by delivering only one version of the content data, which, along with additional data or metadata that are delivered, allows other versions of content to be reconstructed or derived from the delivered version. One embodiment provides accessibility or delivery of multiple versions of video content or a feature on one single product, with two or more versions differing in at least one of color grading and color accuracy (bit depth).

Another embodiment provides that the two versions of content are delivered on a single product in a compatible way, e.g., providing a standard version that is similar to a current home video version, with additional data for the enhanced, e.g., home theatre, version, which does not disturb the decoding and/or playback of the standard version. An example system can be an HD-DVD that has both the standard 8 bit version that is compatible with currently available HD-DVD players, and additional data for the enhancement layer that will be parsed only by special playback devices, such as described in a patent application by Sterling and O'Donnell, “Method and System for Mastering and Distributing Enhanced Color Space Content,” WO2006/050305A1, which is herein incorporated by reference in its entirety. It is understood that there will be applications where version compatibility is an issue, and other applications where such compatibility will not be much of an issue, if at all.

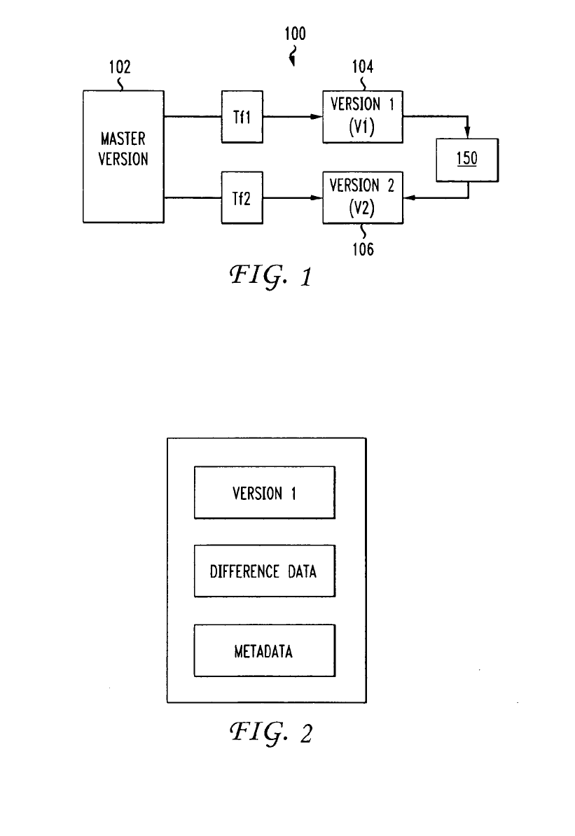

FIG. 1 illustrates a content creation scheme 100, in which a master version 102 of certain content or material can be transformed into a first version 104 using a first transformation function (Tf1). The master version 102 can also be transformed into a second version 106 using a second transformation function (Tf2). The additional data 150 provides a link between the first content version 104 and the second content version 106. More specifically, the additional data 150 includes information that allows the second content version 106 to be reconstructed or derived from the first content version 104. In one embodiment, the additional data 150 includes at least a ColorFunction (which is a function of Tf1 and Tf2), which allows the transformation of the colors of the first version 104 into those of the second version 106.

In one embodiment, content is delivered in a way that no information has to be delivered twice. One example provides a standard version of content and a data stream that upgrades the standard version to the higher (or enhanced) version. In one case, the sum of the data of the standard version and the additional data stream is equal to the data of the enhanced version itself, and preferably, this is also the case after applying a compression scheme like AVC, JPEG2000, and the like.

In general, the two content versions 104 and 106 may differ in one or more of the following characteristics or parameters: color grading, bit depth (color accuracy), spatial resolution and framing.

One aspect of the invention addresses the problem of different color grading used for different bit depths or color accuracy. For example, the product may provide one content version for standard viewing with standard bit depths, and an enhanced version for viewing in a different environment, e.g., home theatre viewing, with increased bit depths.

Thus, compatible encoding of two different versions of the same movie feature can be achieved by providing a standard version and an enhanced version, e.g., for home theatre use, with the two versions having different color accuracy and/or grading, and similar objects in the two versions may have different colors and different bit depths.

If the two versions have the same color grading but different bit depths, then one method of delivering the two different versions may involve providing two individual bit streams or data, namely, a standard version bit stream and an enhancement bit stream, in which the standard version bit stream contains all the information necessary to make a standard version picture, and the enhancement data stream contains all the information needed to improve upon the standard version to form the enhanced content version.

As a simple implementation, the standard version bit stream may contain the MSB (most significant bit) information of a given video picture and the enhancement bit stream would contain the LSB (least significant bit) information of the same given video picture.

However, a more likely scenario is that the two different versions have different color gradings. As an example, they may be graded with a different mid-tone accentuation, different color temperature or a different brightness.

Referring to FIG. 1, if the colors are equal (i.e., color gradings being the same), then in an example where both an 8-bit (standard version) and a 12-bit version (enhanced version) of the same picture have to be delivered, a simple operation would be:

Enhancement Data=V2−[V1*2̂(12−8)] (Eq. 1)

where V1=standard version; and V2=enhanced version.

At the decoding side, the enhanced version (V2) could be reconstructed as:

V2=[V1*2̂(12−8)]+Enhancement Data (Eq. 2)

If the colors are the same for both versions, this is an effective method. The enhancement data is equal to the LSB's of the enhanced version (V2). In the given case with 12 bit and 8 bit, the uncompressed size of the enhancement data may, for example, be about half of the size of the standard version. However, if the colors are different, in a worst case scenario the enhancement data would be up to the same amount as the enhanced version data itself, which is about 1.5 times the standard version data.

To achieve a more optimal result even with differences in color between both versions, a function, referred to as the ColorFunction, is applied to the standard version data before subtracting it from the enhanced version data for obtaining the enhancement data. This is shown in the following equation:

Enhancement Data=V2−[ColorFunction (V1)*2̂(12−8)] (Eq. 3)

At the decoding side, the enhanced version (V2) could be reconstructed as:

V2=[ColorFunction (V1*2̂(12−8)]+Enhancement Data (Eq. 4)

This ColorFunction is the function that transforms the colors of the standard version to the colors of the enhanced version.

As shown in FIG. 2, in one embodiment of this invention, a video or picture content product may be delivered in form of data that includes metadata relating to the ColorFunction, the standard version data for the content, and the enhancement data. In one embodiment, the metadata may be the actual ColorFunction itself. In other embodiments, the metadata contains information about the ColorFunction that allows the ColorFunction to be derived, including, for example, a Look-Up-Table for use in color corrections. For example, ColorFunction may be either a specification of a Look-Up Table defining how to map each color value from the standard version (V1) to that of the enhanced version (V2), or it may be parameters of a polynomial or other function as defined and specified in the metadata or as predefined beforehand, e.g., using the American Society of Cinematographers Color Decision List (ASC CDL), which will be further discussed below.

The ColorFunction would be implemented as a global manipulation function (providing one function per picture, as opposed to localized functions) e.g., by means of a combination of slope, offset and power, or by means of a 1-dimensional or a 3-dimensional Look Up Table. The terms slope, offset and power refer to those used in the ASC CDL representation, but other terms may also be used by one skilled in the art, e.g., slope may be referred to as “gain”, and power may also be referred to as “gamma”. The same ColorFunction is transmitted to the decoding side for decoding.

This ColorFunction can also represent or provide two-dimensional (2-D) or spatial information, in order to allow for local color alterations. For example, separate ColorFunctions may be provided for different parts of the picture or content, e.g., a separate ColorFunction for each individual pixel of the picture, or one per picture segment, where the picture is divided into different picture segments. These ColorFunctions may also be considered as location-specific or segment-specific functions.

Color decisions are normally done scene-wise, so that there is one individual color transformation for each scene. In other words, in the worst case, ColorFunction is to be refreshed with every new scene. However, it is also possible that the same ColorFunction be applied for several scenes or the entire material or content. A scene here is determined as a group of frames within a motion picture.

A mathematical approach for obtaining the ColorFunction has been described by Gao et al. in “Method and Apparatus for Encoding Video Color Enhancement Data, and Method and Apparatus for Decoding Video Color Enhancement Data,” WO2008/019524A1, which is herein incorporated by reference in its entirety.

In the current approach, the transformation function ColorFunction between both versions of pictures (or video content) is obtained from two transformations: namely, color transformation 1 (Tf1), which is the transformation used to create the standard version 104 from the master version, and color transformation 2 (Tf2), which is the transformation used to create the enhanced version 106 from the master version 102.

Specifically, ColorFunction is obtained by combining the inverse of Tf1 with Tf2. (The “inverse of Tf1” refers to performing the reverse of Tf1, e.g., undoing the color transformations previously done by Tf1.) For example, Tf1 and Tf2 are used in post production for creating the corresponding standard and enhanced daughter versions. Tf1 and Tf2 may contain gain, offset and power as parameters, and information relating to these transformations may be used to generate look up tables mentioned above.

In the case that only global operations are used, then there could be problems for the amount of data for the enhancement data in case of local color modifications, as is possible when using the “Power Windows” function from DaVinci, which is a tool that is used for color grading. Furthermore, some colors could be driven into clipping to white or black on one of the two versions, so that the function between both becomes nonlinear, depending on the pixel value. In fact, clipping is a quite common effect. If either of these two cases is true, then one possibility is to accept an increase in size for the enhancement data. In case the size for the enhancement data becomes unacceptably large, then a 2D manipulation function can be chosen, as discussed above, where a separate 1-D transfer function may have to be applied to each pixel or to several group of pixels.

### Color Correction Using ASC-CDL

The implementation of the ColorFunction in embodiments of this invention is further discussed below. During post-production, a given picture or original video content is often modified by a colorist to produce one or more color corrected versions of the content. The American Society of Cinematographers Color Decision List (ASC CDL), which is a list of primary color corrections to be applied to an image, provides a standard format that allows color correction information to be exchanged among equipment and software from different manufacturers.

Under ASC CDL, color correction for a given pixel is given by the following equation:

out=(in*s+o)̂p (Eq. 5)

where out=color graded pixel code value;
in=input pixel code value (0=black, 1=white);
s=slope (any number 0 or greater);
o=offset (any number); and
p=power (any number greater than 0)

In the above equation, * denotes multiplication and ̂ denotes raising a quantity to a power (in this case, p). For each pixel, the equation is applied to the three color values using corresponding parameters for each color channel. Nominal values for the parameters are: 1.0 for s; 0 for o; and 1.0 for p. These parameters s, o and p are selected by a colorist to produce the desired result, i.e., “out” value.

For example, referring back to FIG. 1, during post-production, an original or master version 102 of a picture or video can be transformed into a first version 104, e.g., a standard version of the content using the ASC-CDL equation (Eq. 5), which becomes:

out1=(in*s1+o1)̂p1 (Eq. 6)

where s1, o1 and p1 are parameters selected for producing the color graded pixel value out1 for the first version 104.

Similarly, a second version 106 can be obtained by transforming the master version 102, e.g., enhanced version of the picture or video using the ASC CDL equation:

out2=(in*s2+o2)̂p2 (Eq. 7)

where s2, o1 and p2 are parameters selected for producing the color graded pixel value out2 for the second version 106.

At the receiver, the second version or enhanced version data (e.g., represented by “out2”) has to be reconstructed or derived from the delivered standard version data “out1”. This can be done by solving Eq. (6) and Eq. (7) as follows.

First, invert the function of Eq. (6), i.e., expressing the input pixel value in terms of the output value, as follow:

in=(out1̂(1/p1)−o1)/s1

Second, substitute this expression of “in” into Eq. (7) to obtain:

out2=[(out1̂(1/p1)−o1)*s2/s1+o2]̂p2

This function, or transfer function is computed on RGB pictures or videos, and for each of the three channels (R, G, B) independently.

In the context of the transformation functions Tf1 and Tf2 previously discussed, s1, p1 and o1 are part of Tf1; and s2, p2 and o2 are part of TF2.

### ColorFunction

There are two possibilities of formulating or implementing the ColorFunction. A first implementation is to use the ASC-CDL formula, i.e., Eq. 5, and the corresponding parameters. The parameters may correspond to 18 floating numbers, i.e., six parameters p1, p2, o1, o2, s1, s2 for each of the primary colors Red, Green, and Blue (R, G, B).

A second possibility involves the use of a Look-Up Table. In this case, all possible values are computed at the encoding side (or pre-computed) and transmitted to the receiving side one by one. For instance, if the out2 is of 10-bit precision and out1 of 8-bit, then it needs a computation of 256 (for an 8-bit input) 10-bit values, each for R, G, and B.

Although a color correction of the type ASC-CDL is commonly used, it is also possible to have selective color decisions, e.g., to provide color corrections for a limited range of colors, or for a limited spatial area on the picture. Furthermore, the ColorFunction may also include features to address crosstalks among the three color channels, R, G and B, in which case, the ColorFunction would become more complex.

According to the method or system of the present invention, only the standard version data (e.g., represented by data “out1”), enhancement data and a representation of the ColorFunction are actually delivered to a receiver.

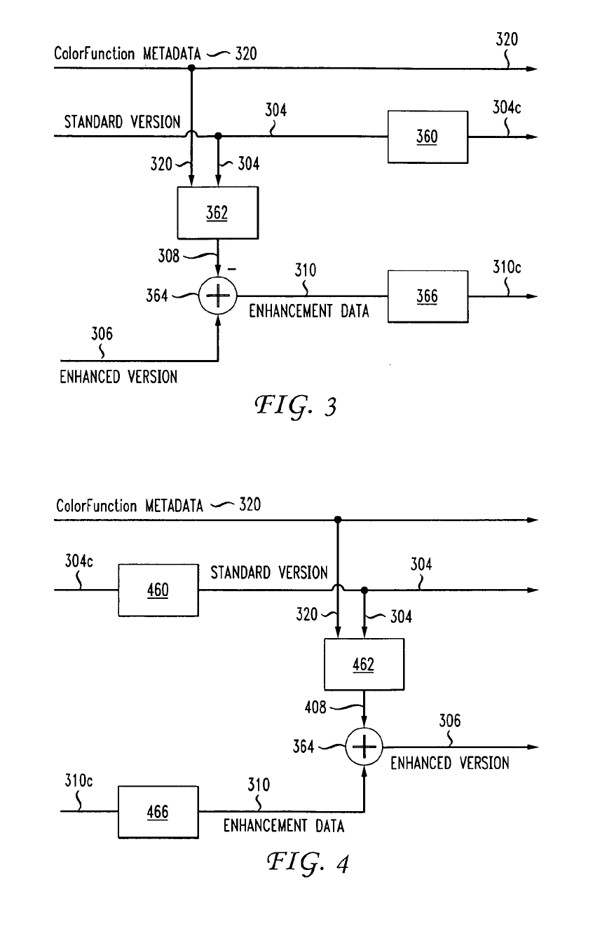

This is shown in FIG. 2 and further explained in FIG. 3. Specifically, FIG. 3 illustrates the steps for encoding data or content for delivery according to one embodiment of the present invention. The data to be delivered or transmitted includes three parts:

1) a compressed first version data 304c obtained from first version data 304;
2) metadata 320 representing a ColorFunction; and
3) a compressed enhancement data 310c obtained from enhancement data 310.

Compressed first version data 304c is produced by compressing a first version data 304 in an encoder 360. For example, the standard version data 304 may be a low quality picture (e.g., low bit depth) with a first set of color decisions intended for certain display devices.

As previously discussed, the ColorFunction of the present invention is obtained by combining transformation functions Tf1 and Tf2, which are used to produce two transformed content versions, e.g., at post-processing or post-production. Specifically, ColorFunction is given by Tf2 multiplied by Inv(Tf1).

According to the present invention, the enhancement or difference data 306 can be generated as follows.

The first version data 304 is provided as input to a “predictor” 362, in which the ColorFunction (obtained from the two known transformation functions Tf1 and Tf2) is applied. The “predictor” may be a processor that is configured to perform the operations involved in applying the ColorFunction. The Inv(Tf1) portion of the ColorFunction results in reversing or un-doing the color decisions previously made (e.g., in post production) for the picture version 304.

In the Tf2 operation of the ColorFunction, the color decisions associated with the second version data 306 (enhanced version or higher quality picture, e.g., higher bit depth) is applied, resulting in a lower quality or standard version picture with colors that are the same as those of the higher quality enhanced version picture 306. This standard version content (e.g., lower quality) 308, with the enhanced version colors (or second set of color decisions), may also be referred to as a “predicted” picture. Since this version 308 is obtained by applying the ColorFunction (or color transformation) to the standard version 304, it may also be referred to as a transformed (or color-transformed) first version.

The difference between this predicted picture version 308 and the actual enhanced version or higher quality picture 306 is computed using processor 364, resulting in the difference or enhancement data 310, which is equal to the quantization or quality difference. The difference data 310 is compressed at encoder 366 to produce compressed data 310c, which is delivered along with compressed data 304c and metadata 320 to a receiver. The metadata, which may be provided either in uncompressed or compressed form, is sent along with the difference data and the first version of content by a transmitter.

FIG. 4 illustrates the steps for decoding the data at a receiver, which includes:

1) metadata 320 relating to the ColorFunction;
2) compressed first version (e.g., standard version) data 304c; and
3) compressed enhancement or difference data 310c.

At the receiver or receiving end, first version data 304 is recovered by decompressing or decoding the compressed data 304c with a decoder 460. The enhancement data 310 is recovered by decompressing or decoding the compressed difference data 310c using decoder 466.

Based on the metadata 320, the ColorFunction is applied to the first version data 304 in processor 462. Similar to the previous discussion for FIG. 3, the application of this ColorFunction to the first version data 304 results in a standard version, lower quality picture (e.g., lower bit depth) but with the color decisions associated with the enhanced version 306, which is denoted as content version 408.

This content version 408 is then combined with the enhancement or difference data 310, e.g., added together in processor 464. Since the difference data 310 represents the quality difference between the standard version 304 and the enhanced version 306, this addition operation effectively reconstructs the enhanced version 306, with the higher quality picture, e.g., higher bit depth, and the second set of color decisions.

### Content Creation for Multiple Displays

Another aspect of the present invention provides a system of creating and delivering content in multiples versions suitable for use with multiple displays with different characteristics, without payload overhead. The display adaptation is done on the content creation side, leaving the control over the look in the creator's hands. Such a scheme also depends on a color space representation that includes wide gamut colors and an unambiguous color representation. A decoder or display device at the receiving or consumer side will receive different content versions, from which a content version that is most appropriate for the connected display will be selected.

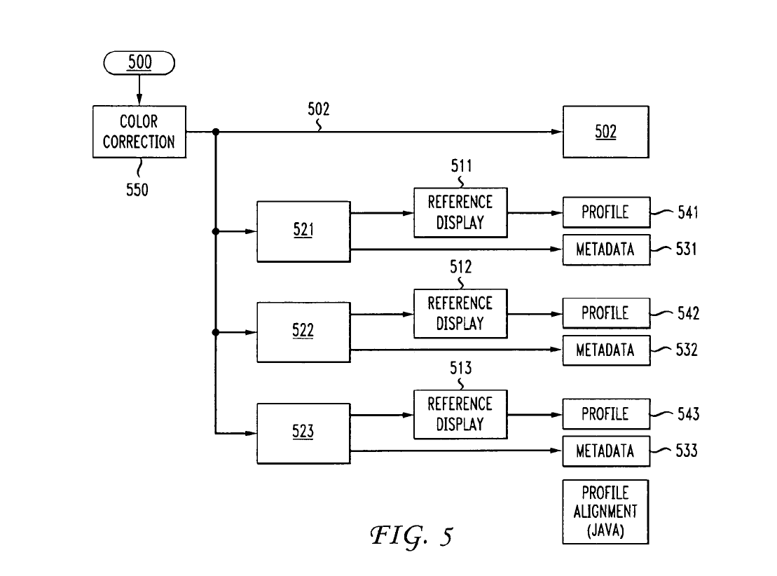

FIG. 5 illustrates a content creation scheme that provides multiple color-corrected versions directed towards different display reference models. An original data file 500 (e.g., from film after editing) is transformed by a processor 550 to produce a color-corrected version 502, which can serve as a first version of the picture data. A range of supported display devices is selected, e.g., reference displays 511, 512, and 513, and the content version 502 is prepared based on the specifications of the range of displays. Examples of these reference displays include High Dynamic Range displays (HDR), Wide Gamut Displays (WG), and ITU-R Bt.709 standard displays (Rec. 709).

A supported display is characterized by the specification of its display and viewing properties, such as color gamut, and brightness range and typical ambient brightness. The range of supported displays depends on the post-production facility, and on the content itself: For instance, if certain content is not meant to be wide gamut, then there would be no need for a wide gamut version of the content. For content or picture where saturated colors are important, a wide gamut reference set is added. If the picture plays with many brightness adaptations of the human eye, then it is important to add a display with high dynamic range capabilities. In general, each production will have a primary display (e.g., HDR), and a number of secondary displays, which preferably also include a “legacy” model display, e.g., CRT display. Typically, the supported displays correspond to devices that are available in the marketplace at the time of content creation.

In accordance with the range of display models, color-corrected version 502 is further transformed in one or more image processors, e.g., processors 521, 522 and 523, which generates respective transformed images (e.g., with colors being transformed) as well as different mapping metadata 531, 532 and 533 for the corresponding displays. The mapping metadata is similar to the ColorFunction previously described. Depending on the embodiments, they may be the same or different functions for use with various displays. Furthermore, the metadata may be used to support other applications, including, for example, for decoding other versions of content such as directors' or cinematographers' versions (not just colorists' versions).

In one embodiment, the system is configured such that the image transform for the secondary display types is an automatic or semi-automatic process.

The display profiles of the reference displays, e.g., display profiles 541, 542 and 543, are also provided as part of the data to be delivered. A “profile alignment” (Java code), which performs mapping or the application of the transfer function, is also included as a part of the data to be delivered.

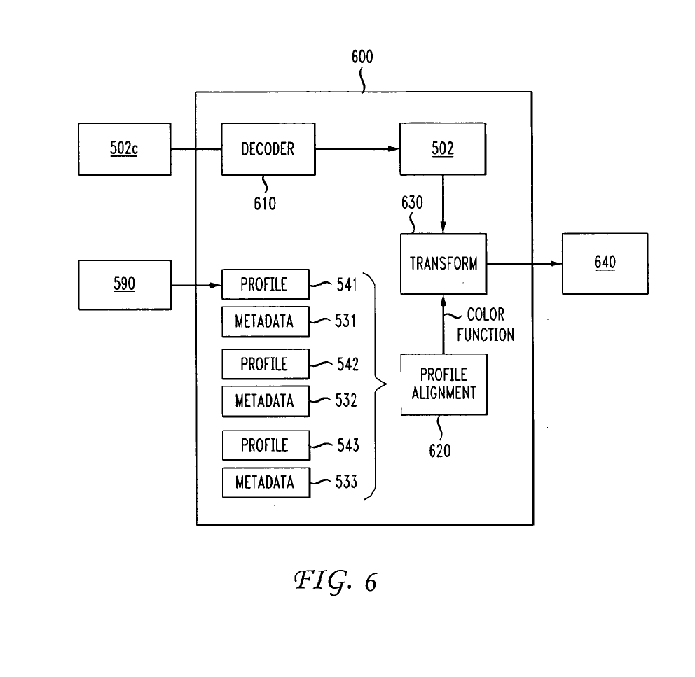

At the receiving side shown in FIG. 6, a consumer device 600 (e.g., set-top box, player, or display) receives the compressed picture data 502c and a set of metadata 590. A decoder 610 decompresses the compressed data 502c to produce picture data 502. The video content decoder may be located inside a decoder/player box, as well as in the display itself. It is also possible to perform the MPEG-decoding in the decoder/player, and the color transform in the display. In this example, both MPEG-decoding and color transform are performed in the decoder/player.

The set of metadata 590 is also decoded or separated into respective portions such as the display profiles 541, 542 and 543 and mapping metadata 531, 532 and 533.

A Java profile alignment code 620 is used to select and/or apply the proper profile or ColorFunction.

In this example, content with enhanced bit depth, e.g., 10/12 bit, is MPEG-decoded, and then transformed according to a ColorFunction (may also be referred to as transform specification) in a transform processor 630 before the content is provided to the display 640.

As discussed above, the ColorFunction is not calculated in the decoder 610. Instead, it (or a representation of it, e.g., metadata) is delivered with the content. In this embodiment, multiple ColorFunctions are delivered as metadata.

The transform processor 630 selects a ColorFunction appropriate for the display 640 based on two sets of metadata received at the decoder/player 600. One set of metadata, called “display metadata”, contains information about the connected display, such as color gamut, brightness range, and so on. Another set of metadata, called content metadata, consists of several pairs of “reference display metadata” and “transform metadata”. By matching “reference display metadata” with “display metadata” from the connected display, the processor 630 can determine which set of content metadata would provide the best match for display 640, and selects the corresponding ColorFunction.

Since the “transform metadata” can change scene-wise, i.e., on a scene-by-scene basis, the ColorFunction can also update in similar fashion.

The transform processor 630 has means to transform uncompressed video data according to the ColorFunction in real time. For this, it features hardware or software implementations of a Look-Up-Table, or a parametric transform implementation, or a combination of both.

This solution provides content that brings added value to the viewer by utilizing the potential of today's display technologies. Display makers do not have to improve upon the content in order to utilize the potential of their displays.

However, metadata is required to communicate mapping data and reference display properties. Although this new delivery scheme allows enhanced delivery based on wide gamut and high bit depth, it can also be applied to content delivery with other options. Such delivery schemes can be used for many different applications, including, for example, motion picture business, post-production, DVD, video on demand (VoD), and so on.

While the forgoing is directed to various embodiments of the present invention, other and further embodiments of the invention may be devised without departing from the basic scope thereof. As such, the appropriate scope of the invention is to be determined according to the claims, which follow.

1. A method of preparing video content for delivery, comprising:
providing a first version of video content;
providing metadata for use in transforming at least a first parameter value associated with the first version to at least a second parameter value associated with a second version of content;
providing difference data representing at least one difference between the first version of video content and the second version of video content;
wherein the first version of content is related to a master version through a first function, and the second version of video content is related to the master version through a second function; and
wherein the metadata is derived from the first function and the second function.

2. The method of claim 1, wherein the first function and the second function are different color transformation functions for transforming the master version to the first and second versions, the metadata is derived from a combination of the second function with an inverse of the first function, and the first parameter value and the second parameter value are color-related values.

3. The method of claim 1, wherein the first version and the second version of content differ in at least one of color grading and bit depth.

4. The method of claim 3, wherein the first parameter value and the second parameter value are color grading values.

5. The method of claim 1, further comprising:
representing the first function and the second function by an equation:
out=(in*s+o)̂p;
where “out” is an output color graded pixel code value, “in” is an input pixel code value, “s” is a number greater than or equal to zero, “o” is any number, and “p” is any number greater than zero.

6. The method of claim 1, wherein the first function and second function are color transformation functions used in post production.

7. The method of claim 1, wherein the at least one difference between the first version and the second version is a bit depth.

8. The method of claim 1, wherein the difference data is generated by:
generating a transformed first version by using the metadata; and
obtaining a difference between the transformed first version and the second version.

9. The method of claim 8, wherein the transformed first version has a color grading of the second version, and has a bit depth of the first version.

10. The method of claim 1, further comprising:
delivering the first version of video content, the difference data and the metadata to a receiver;
wherein the receiver is one of: a first type of receiver compatible only with the first version of video content, and a second type of receiver compatible with the second version of video content.

11. The method of claim 10, further comprising:
providing a plurality of display profiles representing characteristics of different display devices.

12. A system, comprising:
at least one processor configured for generating difference data using a first version of content, a second version of content, and metadata for use in transforming at least a first parameter value associated with the first version to at least a second parameter value associated with the second version of content;
wherein the first version of content is related to a master version through a first function, and the second version of video content is related to the master version through a second function; and
wherein the metadata is derived from the first function and the second function.

13. The system of claim 12, wherein the first function and the second function are different color transformation functions for transforming the master version to the first and second versions, the metadata is derived from a combination of the second function with an inverse of the first function, and the first parameter value and the second parameter value are color-related values.

14. The system of claim 12, further comprising:
at least one encoder for encoding the first version of content and the difference data.

15. The system of claim 12, wherein the first version and the second version of content differ in at least one of color grading and bit depth.

16. The system of claim 12, further comprising:
a transmitter for transmitting the first version of content, the difference data and the metadata.

17. A system, comprising:
a decoder configured for decoding data to generate at least a first version of content and a difference data representing at least one difference between the first version of content and a second version of content; and
a processor for generating the second version of content from the first version of video content, the difference data, and metadata provided to the processor;
wherein the first version of content is related to a master version through a first function, and the second version of video content is related to the master version through a second function; and
wherein the metadata is derived from the first function and the second function, for use in transforming at least a first parameter value associated with the first version to at least a second parameter value associated with the second version of content.

18. The system of claim 17, wherein the first function and the second function are different color transformation functions for transforming the master version to the first and second versions, the metadata is derived from a combination of the second function with an inverse of the first function, and the first parameter value and the second parameter value are color-related values.

19. The system of claim 17, wherein the first version and the second version of content differ in at least one of color grading and bit depth.
